(19) United States
(12) Patent Application Publication
(10) Pub. No.: US 2021/0133597 A1
(43) Pub. Date: May 6, 2021

(54) WEATHER TRIGGER MAPPING ENGINE

(71) Applicant: International Business Machines Corporation, Armonk, NY (US)

(72) Inventors: David Arthur Gold, Spring, TX (US); Leonard G. Polhemus, JR., Wappingers Falls, NY (US); Robert Donald Hamilton, Cambridge, MA (US); Declan Michael Brennan, Fairfield, CT (US)

(21) Appl. No.: 16/672,576

(22) Filed: Nov. 4, 2019

(51) Int. Cl. G06N 5/02; G06F 16/28; G06F 16/23; G06F 16/29; G06Q 30/02

(52) U.S. Cl. CPC G06N 5/025; G06F 16/285; G06Q 30/0201; G06F 16/29; G06Q 30/0206; G06F 16/2365

(57) ABSTRACT

In an approach to mapping marketing triggers across geographies, a computer receives one or more variables associated with one or more rulesets. A computer retrieves data corresponding to the one or more variables. A computer sorts the retrieved data by season. A computer computes a seasonal average for each variable by associated postal code. A computer trains a self-organizing map to arrange the data associated with the source geography postal codes into one or more source clusters. A computer maps the retrieved data and the computed data associated with the target geography to the one or more source clusters, thereby creating target counterpart clusters that correspond with at least one of the one or more source clusters. A computer applies one or more cluster rulesets associated with the one or more source clusters to the corresponding one or more target counterpart clusters. A computer outputs one or more bucket sheets.

### BACKGROUND OF THE INVENTION

The present invention relates generally to the field of data analytics, and more particularly to mapping weather-dependent marketing triggers across geographies.

An artificial neural network, often called an artificial neural net or neural net, is used in many applications to recognize a pattern or a function for which the neural net has been trained to recognize. An artificial neural network is a lattice of individual artificial neurons that are connected to each other. The artificial neurons are often arranged in layers in a lattice with the outputs of the neurons in a layer connected to the inputs of the neurons in a next layer. An artificial neuron is modeled on a biological neuron, which is comprised of dendrites that carry input signals (often originating in the outputs of other neurons) to a cell body that processes the inputs and produces an output signal on an axon. The signal on the axon is often an input to one or more synapses that each provide a connection to one or more dendrites (inputs) on other neurons.

A self-organizing map (SOM) is a type of artificial neural network that is trained using unsupervised learning to produce a low-dimensional (typically two-dimensional), discretized representation of the input space of the training samples, called a map, and is therefore a method to do dimensionality reduction. Self-organizing maps differ from other artificial neural networks as they apply competitive learning as opposed to error-correction learning (such as backpropagation with gradient descent), and in the sense that they use a neighborhood function to preserve the topological properties of the input space. SOMs operate in two modes: training and mapping. “Training” builds the map using input examples (a competitive process, also called vector quantization), while “mapping” automatically classifies a new input vector.

Modern enterprises are competing in global markets that are increasingly complex and dynamic. Globalization has expanded the universe of suppliers, competitors, channel partners, and customers with which an enterprise interacts, directly or indirectly, in the course of their business. These increasingly competitive markets can make even small competitive advantages yield large dividends in terms of financial performance. Systems and services have been developed to assist market participants (enterprises, investors, etc.) in gathering intelligence relating to the global marketplace.

### SUMMARY

Embodiments of the present invention disclose a method, a computer program product, and a system for mapping weather-dependent marketing triggers across geographies. The method may include one or more computer processors receiving one or more variables associated with one or more rulesets. One or more computer processors retrieve data corresponding to the one or more variables, wherein the retrieved data is organized by a plurality of postal codes associated with the retrieved data, and wherein at least one of the plurality of postal codes belongs to a source geography and at least one of the plurality of postal codes belongs to a target geography. One or more computer processors sort the retrieved data by season. One or more computer processors compute a seasonal average for each variable by associated postal code. One or more computer processors train a self-organizing map to arrange the retrieved data and the computed data associated with the source geography postal codes into one or more source clusters. One or more computer processors map the retrieved data and the computed data associated with the target geography to the one or more source clusters, thereby creating one or more target counterpart clusters that correspond with at least one of the one or more source clusters. One or more computer processors apply one or more cluster rulesets associated with the one or more source clusters to the corresponding one or more target counterpart clusters. One or more computer processors output one or more bucket sheets, wherein each of the one or more bucket sheets is a master list of each bucket which contains the rulesets by postal code and by season for each bucket, and wherein each of the one or more bucket sheets corresponds to one of the one or more target counterpart clusters.

### BRIEF DESCRIPTION OF THE DRAWINGS

FIG. 1 is a functional block diagram illustrating a distributed data processing environment, in accordance with an embodiment of the present invention;

FIG. 2 is a flowchart depicting operational steps of a trigger mapping engine, on a server computer within the distributed data processing environment of FIG. 1, for mapping marketing triggers across geographies, in accordance with an embodiment of the present invention;

FIG. 3 is an example of a cluster map generated by a self-organizing map after training by the trigger mapping engine of FIG. 1, in accordance with an embodiment of the present invention;

FIG. 4A is an example of a bucket sheet output by the trigger mapping engine of FIG. 1, in accordance with an embodiment of the present invention;

FIG. 4B is an example of a trigger sheet generated by the trigger mapping engine of FIG. 1, in accordance with an embodiment of the present invention; and

FIG. 5 depicts a block diagram of components of the server computer executing the trigger mapping engine within the distributed data processing environment of FIG. 1, in accordance with an embodiment of the present invention.

### DETAILED DESCRIPTION

In the field of product marketing, rulesets exist that determine when and where to send marketing content in the U.S. based on weather, seasonality, and geographic region. Rulesets may be specific to a product or brand, a sector, a category, or an activity. Developing similar rules for other global markets is hampered by a lack of granular business data sets in the geographies. In addition, the task is further complicated by the need for geography specific compliance, such as the recent data storage requirements defined by the European Union (EU) as General Data Protection Regulation (GDPR), which can reduce the availability of personal information. A marketing trigger may apply to a specific product, brand, sector, category, or activity. Existing U.S. marketing triggers leverage machine-learned relationships between consumer preference for specific brands and activities (i.e., the target variable) and variables such as weather, location, and season. Ideally, mapping U.S. locations to their most similar global counterparts yields a model that includes trigger rulesets for geographies outside of the U.S. However, existing trigger rulesets are part of a complex data hierarchy, and conditions beyond merely weather have to be accounted for in any mapping scheme to ensure that geographic analogs to U.S. regions are similar both climatologically and demographically.

Embodiments of the present invention recognize that efficiency may be gained by mapping known marketing trigger rulesets to global counterparts on the basis of weather and demographics to create global rulesets without relying on personal information for the formulation of marketing tactics, thus shifting marketing rules from one location to another without referencing any details of specific users. Embodiments of the present invention also recognize the process of identifying distinct market clusters can be improved by applying network-based unsupervised learning to the identification of market clusters. Implementation of embodiments of the invention may take a variety of forms, and exemplary implementation details are discussed subsequently with reference to the Figures.

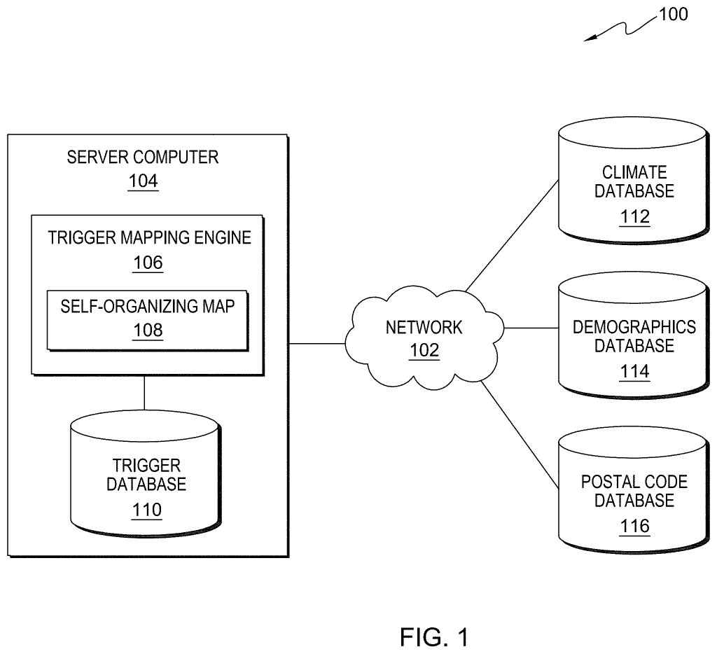

FIG. 1 is a functional block diagram illustrating a distributed data processing environment, generally designated 100, in accordance with one embodiment of the present invention. The term “distributed” as used herein describes a computer system that includes multiple, physically distinct devices that operate together as a single computer system. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Distributed data processing environment 100 includes server computer 104, climate database 112, demographics database 114, and postal code database 116, interconnected over network 102. Network 102 can be, for example, a telecommunications network, a local area network (LAN), a wide area network (WAN), such as the Internet, or a combination of the three, and can include wired, wireless, or fiber optic connections. Network 102 can include one or more wired and/or wireless networks capable of receiving and transmitting data, voice, and/or video signals, including multimedia signals that include voice, data, and video information. In general, network 102 can be any combination of connections and protocols that will support communications between server computer 104 and climate database 112, demographics database 114, and postal code database 116, and other computing devices (not shown) within distributed data processing environment 100.

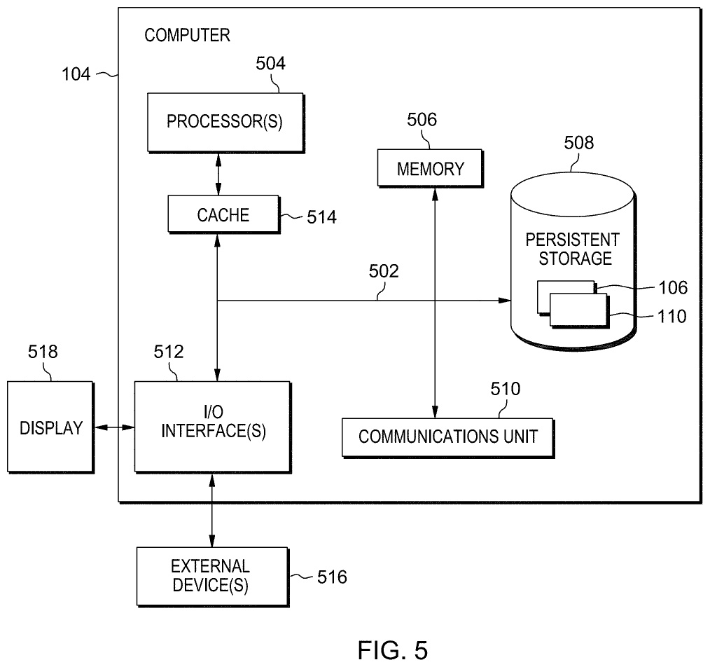

Server computer 104 can be a standalone computing device, a management server, a web server, a mobile computing device, or any other electronic device or computing system capable of receiving, sending, and processing data. In other embodiments, server computer 104 can represent a server computing system utilizing multiple computers as a server system, such as in a cloud computing environment. In another embodiment, server computer 104 can be a laptop computer, a tablet computer, a netbook computer, a personal computer (PC), a desktop computer, a personal digital assistant (PDA), a smart phone, or any programmable electronic device capable of communicating with climate database 112, demographics database 114, postal code database 116, and other computing devices (not shown) within distributed data processing environment 100 via network 102. In another embodiment, server computer 104 represents a computing system utilizing clustered computers and components (e.g., database server computers, application server computers, etc.) that act as a single pool of seamless resources when accessed within distributed data processing environment 100. Server computer 104 includes trigger mapping engine 106 and trigger database 110. Server computer 104 may include internal and external hardware components, as depicted and described in further detail with respect to FIG. 5.

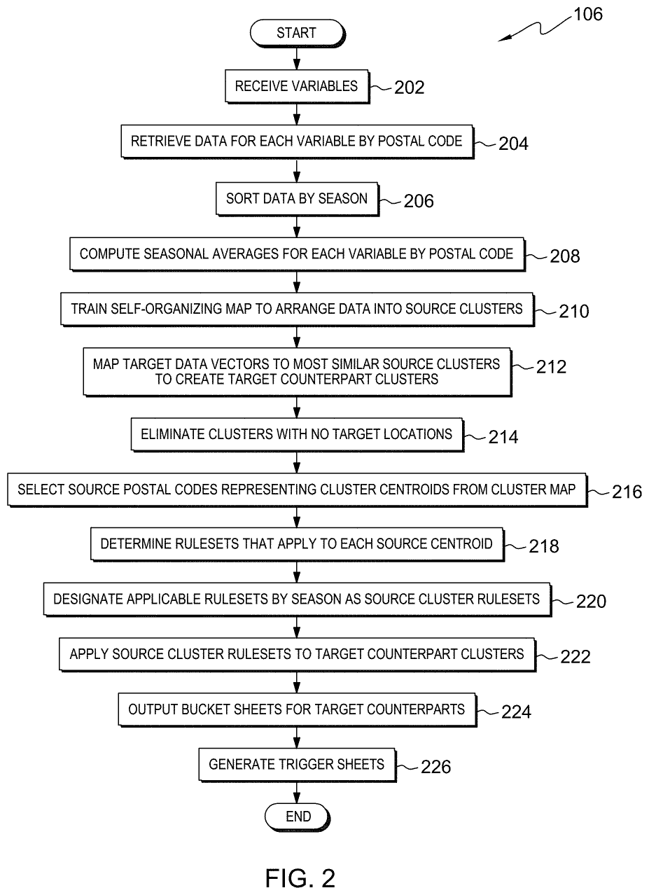

Trigger mapping engine 106 maps established marketing triggers based on climatological and demographic data of a source geography to one or more target geographies that exhibit similar seasonal and demographic data. Trigger mapping engine 106 receives climatological and demographic variables upon which trigger mapping is based. Trigger mapping engine 106 retrieves data for each variable by source geography postal code and target geography postal code. Trigger mapping engine 106 sorts the retrieved data by season. Trigger mapping engine 106 computes seasonal averages for each variable by postal code. Trigger mapping engine 106 trains a self-organizing map with the computed data corresponding to the source geography to arrange the data into source clusters in a cluster map. Trigger mapping engine 106 maps target data vectors to the most similar source clusters to create target counterpart clusters, eliminating any clusters with no corresponding target locations. Trigger mapping engine 106 selects source postal codes representing the centroid of a cluster from the cluster map, i.e., the location of the center, or a point closest to the center, of the cluster. Trigger mapping engine 106 determines rulesets that apply to each source centroid. Trigger mapping engine 106 designates applicable centroid rulesets by season as source cluster rulesets. Trigger mapping engine 106 applies the source cluster rulesets to target counterpart clusters. Trigger mapping engine 106 outputs bucket sheets that include all buckets for all locations, where a bucket is a specific, pre-defined condition based on at least one of the received variables. Based on mapping the bucket sheets to the target counterpart clusters, trigger mapping engine 106 generates trigger sheets for the target geographies. Trigger mapping engine 106 includes an instance of self-organizing map (SOM) 108. Trigger mapping engine 106 is depicted and described in further detail with respect to FIG. 2.

In the depicted embodiment, SOM 108 is a component of trigger mapping engine 106. In another embodiment, SOM 108 may reside elsewhere in distributed data processing environment 100 provided that trigger mapping engine 106 has access to SOM 108. As would be recognized by a person of skill in the art, SOM 108 is a competitive learning neural network based on unsupervised learning, which means that no human intervention is needed during the learning, and that little needs to be known about the characteristics of the input data. SOM 108 easily visualizes multidimensional space. Specifically, trigger mapping engine 106 trains SOM 108 using seasonal averages of a plurality of variables discussed with respect to trigger mapping engine 106 using only source geography data. SOM 108 spatially arranges a pre-defined number of clusters according to pattern similarity between the clusters. The patterns are defined by the variables. The result is a cluster map that displays a topologically sensible and robust clustering of the data. In addition to the clusters, SOM 108 outputs cluster centroids of source postal codes by minimum Euclidian distance, as would be recognized by a person of skill in the art. In an embodiment, trigger mapping engine 106 trains SOM 108, or an updated version of SOM 108, to include updated data for one or more of the variables. For example, if a more current averaging period becomes available for climatological variables, then trigger mapping engine 106 can re-train SOM 108 to include the new data. In another example, if additional or updated measures of demographic data are available, then trigger mapping engine 106 can re-train SOM 108 to include the new data. In another embodiment, trigger mapping engine 106 can re-train SOM 108 with more or less or different variables than trigger mapping engine 106 used originally to train SOM 108.

Trigger database 110, climate database 112, demographics database 114, and postal code database 116 are each a repository for data used by trigger mapping engine 106. Trigger database 110, climate database 112, demographics database 114, and postal code database 116 may each represent one or more databases. In the depicted embodiment, trigger database 110 resides on server computer 104. In another embodiment, trigger database 110 may reside elsewhere within distributed data processing environment 100 provided trigger mapping engine 106 has access to trigger database 110. In the depicted embodiment, climate database 112, demographics database 114, and postal code database 116 reside within distributed data processing environment 100, however the three databases are outside of server computer 104. In other embodiments, one or more of climate database 112, demographics database 114, and postal code database 116 may reside on server computer 104. A database is an organized collection of data. Trigger database 110, climate database 112, demographics database 114, and postal code database 116 can each be implemented with any type of storage device capable of storing data and configuration files that can be accessed and utilized by trigger mapping engine 106, such as a database server, a hard disk drive, or a flash memory. Trigger database 110 stores data retrieved and/or computed by trigger mapping engine 106 for a plurality of calculations, including training SOM 108, as well as data generated by SOM 108. Trigger database 110 also stores rules and rulesets used for source triggers. Climate database 112 stores data relating to a plurality of weather-based variables used by trigger mapping engine 106, including, but not limited to, average temperature, average precipitation, average relative humidity, and average wind speed, each of which correspond to a specific geography. For example, climate database 112 may store climatological data from the U.S. National Centers for Environmental Prediction (NCEP). Demographics database 114 stores data relating to a plurality of demographics variables used by trigger mapping engine 106, including, but not limited to, population density and income per capita, each of which correspond to a specific geography. Demographics database 114 may store, for example, data from the U.S. Internal Revenue Service (IRS) Census data. In another example, demographics database 114 may also store U.S. IRS statistics of income data. In a further example, demographics database 114 may store Nomenclature of Territorial Units for Statistics (NTUS) 3 European population, region geographies, and income data. Postal code database 116 stores postal codes for a plurality of locations in the U.S. and a plurality of other countries in the world.

FIG. 2 is a flowchart depicting operational steps of trigger mapping engine 106, on server computer 104 within distributed data processing environment 100 of FIG. 1, for mapping marketing triggers across geographies, in accordance with an embodiment of the present invention.

Trigger mapping engine 106 receives variables (step 202). Trigger mapping engine 106 receives a selection of one or more variables which characterize market segments. In one embodiment, trigger mapping engine 106 receives one or more climatological variables. For example, climatological variables may include, but are not limited to, average temperature, average relative humidity, average precipitation, and average wind speed. In another embodiment, trigger mapping engine 106 receives one or more demographic, or socioeconomic, variables. For example, demographic variables may include, but are not limited to, population density and income per capita. In a further embodiment, trigger mapping engine 106 may receive a mix of one or more climatological and demographic variables. In one embodiment, trigger mapping engine 106 receives a total of six variables. In the embodiment, four of the variables are climatological and two of the variables are demographic.

Trigger mapping engine 106 retrieves data for each variable by postal code (step 204). For each of the received variables, trigger mapping engine 106 retrieves data organized by postal code for the source geography and for the target geography. Trigger mapping engine 106 retrieves the postal codes from postal code database 116. For any climatological variables, trigger mapping engine 106 retrieves data by postal code from climate database 112. For any demographic variables, trigger mapping engine 106 retrieves data by postal code from demographics database 114.

Trigger mapping engine 106 sorts data by season (step 206). Trigger mapping engine 106 sorts the retrieved data by season. In one embodiment, trigger mapping engine 106 uses dates of the astronomical seasons for the current year. In another embodiment, trigger mapping engine 106 uses the meteorological seasons for sorting the data. In a scenario where the marketing triggers are influenced by human sentiment, trigger mapping engine 106 sorts by meteorological season since human activity may be sensitive to the meteorological seasons. In one embodiment, trigger mapping engine 106 sorts the data by the four standard seasons: winter, spring, summer, and autumn. In another embodiment, trigger mapping engine 106 may break down the four standard seasons into a plurality of sub-seasons.

Trigger mapping engine 106 computes seasonal averages for each variable by postal code (step 208). For each postal code in the source geography and each postal code in the target geography, trigger mapping engine 106 computes the average of each variable by season.

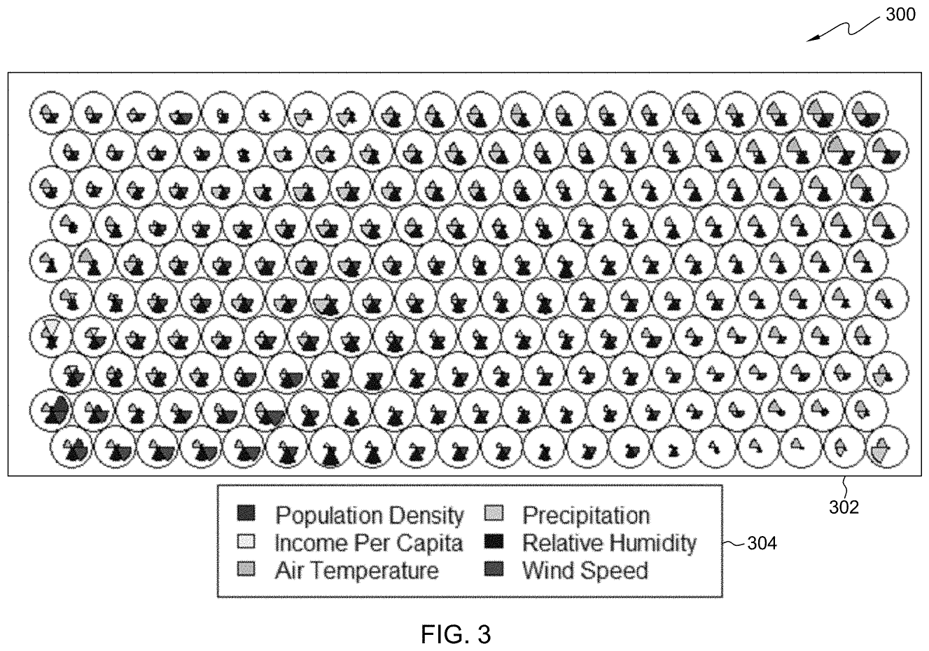

Trigger mapping engine 106 trains self-organizing map (SOM) 108 to arrange data into source clusters (step 210). Trigger mapping engine 106 feeds the retrieved and computed data for the source geography into SOM 108. SOM 108 spatially arranges a pre-defined number of clusters according to pattern similarity between the clusters. The patterns are defined by the received variables. As a result of the training, SOM 108 generates a map that displays the clustering of the data, i.e., a cluster map. In one embodiment, the pre-defined number of clusters to develop may depend on, for example, the number of designated marketing areas (DMAs) in the source geography, as would be recognized by a person of skill in the art. SOM 108 is depicted and described in further detail with respect to FIG. 3.

Trigger mapping engine 106 maps target data vectors to most similar source clusters to create target counterpart clusters (step 212). Target geography data vectors are defined in terms of the same variables selected for source geography clusters by postal code and season. In one embodiment, trigger mapping engine 106 measures similarity between source clusters and target data vectors utilizing a threshold Euclidian distance to the center of a cluster in the cluster map generated by SOM 108. For example, if the source geography is the U.S. and the target geography is Europe, then trigger mapping engine 106 maps European postal codes to U.S. clusters by determining the locations in Europe most similar to specific locations in the U.S. In an example cluster called “Winter” with six variables, i.e., temperature, precipitation, relative humidity, wind speed, population density, and income per capita, Sasakwa, Okla., is found to have averages of 6 degrees Celsius temperature, 49.7 mm/day precipitation, 65% relative humidity, 9 km/hour wind speed, 150 people/square mile, and $19,500 income per capita, which, combined by SOM 108, create a distance of 0.79 to the center of the source cluster. Trigger mapping engine 106 maps San Vicente del Palacio, Spain, to the same cluster because that location experiences on average 4 degrees Celsius temperature, 58.2 mm/day precipitation, 85% relative humidity, 12 km/hour wind speed, 232 people/square mile, and $26,000 income per capita, which, combined by SOM 108, create a distance of 0.80 to the center of the counterpart cluster. If, in the example, the threshold distance to the center of the cluster is defined as less than 0.85 and greater than 0.75, then trigger mapping engine 106 considers the two locations as similar. In embodiments where dimensionality is high, trigger mapping engine 106 can use other distance metrics. For example, trigger mapping engine 106 may utilize kernel transformations, some of which may amount to creating weights that are a non-linear function of the data.

Trigger mapping engine 106 eliminates clusters with no target locations (step 214). Responsive to mapping target counterpart clusters to similar source clusters, trigger mapping engine 106 determines whether any of the source clusters have no target counterpart clusters, and, if so, then trigger mapping engine 106 removes the source clusters with no counterparts from the data set.

Trigger mapping engine 106 selects source postal codes representing cluster centroids from cluster map (step 216). Based on the Euclidian distance between postal codes within the clusters of the cluster map generated by SOM 108, trigger mapping engine 106 selects a postal code from each cluster to represent the center of the cluster, i.e., the postal code with the shortest distances from all other postal codes in the cluster.

Trigger mapping engine 106 determines rulesets that apply to each source centroid (step 218). Trigger mapping engine 106 reviews rulesets stored in trigger database 110 to determine which rulesets apply to the source postal code designated as the centroid of a source cluster. A ruleset is a collection of rules that define a bucket in a specific location. For example, for a bucket defined as “cold weather,” a ruleset for Minnesota may be any temperature less than 30 degrees Fahrenheit, while the ruleset for Arizona may be any temperature less than 60 degrees Fahrenheit. Rulesets may include one or more rules and may differ by season. For example, a trigger for marketing ice cream in a specific location may include a ruleset that includes minimum air temperature, a minimum relative humidity, and no forecasted precipitation in a threshold time period. If the conditions of the ruleset are met, then the corresponding trigger is activated.

Trigger mapping engine 106 designates applicable rulesets by season as source cluster rulesets (step 220). Responsive to determining which rulesets apply to the centroid postal code of the source cluster, trigger mapping engine 106 designates the applicable rulesets as the rulesets for that cluster. Thus, each cluster is associated with one set of rules per season.

Trigger mapping engine 106 applies source cluster rulesets to target counterpart clusters (step 222). Trigger mapping engine 106 maps each ruleset designated as a source cluster ruleset to the corresponding target counterpart cluster, such that each trigger mapping engine 106 assigns a target counterpart cluster an applicable ruleset. Using the example discussed above, trigger mapping engine 106 assigns the ruleset for the source cluster that includes Sasakwa, Okla. to the target counterpart cluster that includes San Vicente del Palacio, Spain.

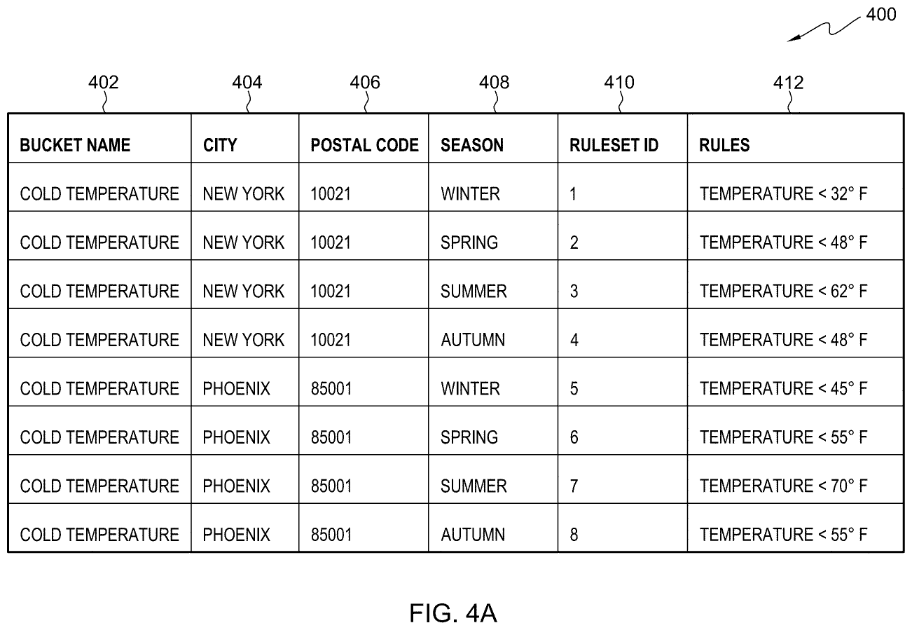

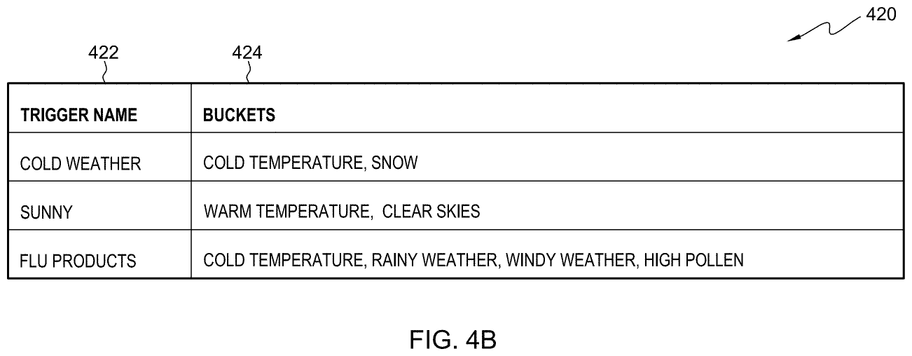

Trigger mapping engine 106 outputs bucket sheets for target counterparts (step 224). As described above, a bucket is a specific, pre-defined condition based on at least one of the received variables. A bucket sheet is a master list of each bucket which contains all the rulesets by postal code and by season for that bucket. Trigger mapping engine 106 outputs bucket sheets associated with the target counterpart clusters. In one embodiment, the number of buckets per bucket sheet may be limited to ensure platform readability. For example, a bucket sheet may be limited to 50 buckets per sheet. An example of a bucket sheet is discussed with respect to FIG. 4A.

Trigger mapping engine 106 generates trigger sheets (step 226). Trigger mapping engine 106 maps marketing triggers previously defined for the source geography to the applicable buckets defined for the target geography and generates a master table called a trigger sheet. Trigger mapping engine 106 generates a trigger sheet for each target counterpart cluster of postal codes. In one embodiment, per the mapping, if a bucket condition exists in a target counterpart cluster, then trigger mapping engine 106 recommends activating the marketing trigger. In one embodiment, per the mapping, if a bucket condition exists in a target counterpart cluster, then trigger mapping engine 106 automatically activates the marketing trigger. An example of a trigger sheet is discussed with respect to FIG. 4B.

FIG. 3 is cluster map 300 generated by SOM 108 after training by trigger mapping engine 106 of FIG. 1, for, in accordance with an embodiment of the present invention. Cluster map 300 includes map 302 and legend 304. Legend 304 describes six variables mapped by SOM 108, which include two demographic variables, i.e., population density and income per capita, and four climatological variables, i.e., air temperature, precipitation, relative humidity, and wind speed. Each circle within map 302 represents a combination of conditions described by the six variables and learned by SOM 108. There may be a plurality of individual postal codes represented in each circle, i.e., the postal codes whose combination of conditions are closest to the cluster per the chosen distance metric. SOM 108 maps the six variables for each postal code and then places postal codes with the most similar data in proximity to each other, creating clusters.

FIG. 4A is example bucket sheet 400 output by trigger mapping engine 106 of FIG. 1, in accordance with an embodiment of the present invention. Example bucket sheet 400 describes one bucket and is a collection of all applicable rulesets for that bucket. Each row of example bucket sheet 400 represents a ruleset. Example bucket sheet 400 includes six columns. Bucket name 402 lists the name of the bucket for which example bucket sheet 400 applies, specifically, cold temperature. City 404 lists a city included in the bucket, specifically New York and Phoenix. Postal code 406 lists the postal code in which the city resides, specifically postal code 10021 for New York and postal code 85001 for Phoenix. Season 408 lists the various seasons for which the bucket applies, specifically, for each postal code, four seasons are listed, i.e., winter, spring, summer, and autumn. Ruleset ID 410 lists an identification number for each ruleset used for the postal code by season. Rules 412 lists the rules included in the ruleset ID, specifically what temperature applies to the bucket for the season and the location. For example, ruleset 3 defines that for postal code 10021 in summer, cold temperature applies when the temperature is less than 62 degrees Fahrenheit. Rules 412 is a simplified example. In general, there may be a plurality of rules in a ruleset, each applying to a selected variable.

FIG. 4B is example trigger sheet 420 generated by trigger mapping engine 106 of FIG. 1, in accordance with an embodiment of the present invention. Trigger mapping engine 106 generates the trigger sheets by mapping triggers to every applicable bucket per row. Example trigger sheet 420 includes two columns, trigger name 422 and buckets 424. As seen in trigger name 422, triggers may apply to, for example, a condition, i.e., “cold weather” and “sunny,” or a product type for which marketing may be performed, i.e., “flu products.” Buckets 424 lists one or more buckets for which the trigger may be used. For example, if conditions in a location fall within the rulesets of the buckets named “cold temperature” and/or “snow,” then the trigger “cold weather” applies, and trigger mapping engine 106 recommends activating the marketing trigger “cold weather.” To port the source geography mappings of triggers to buckets for each target geography, trigger mapping engine 106 generates trigger-to-bucket mappings for each target geography based on pre-assigned mappings in the source geography.

FIG. 5 depicts a block diagram of components of server computer 104 within distributed data processing environment 100 of FIG. 1, in accordance with an embodiment of the present invention. It should be appreciated that FIG. 5 provides only an illustration of one implementation and does not imply any limitations with regard to the environments in which different embodiments can be implemented. Many modifications to the depicted environment can be made.

Server computer 104 can include processor(s) 504, cache 514, memory 506, persistent storage 508, communications unit 510, input/output (I/O) interface(s) 512 and communications fabric 502. Communications fabric 502 provides communications between cache 514, memory 506, persistent storage 508, communications unit 510, and input/output (I/O) interface(s) 512. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses.

Memory 506 and persistent storage 508 are computer readable storage media. In this embodiment, memory 506 includes random access memory (RAM). In general, memory 506 can include any suitable volatile or non-volatile computer readable storage media. Cache 514 is a fast memory that enhances the performance of processor(s) 504 by holding recently accessed data, and data near recently accessed data, from memory 506.

Program instructions and data used to practice embodiments of the present invention, e.g., trigger mapping engine 106 and trigger database 110, are stored in persistent storage 508 for execution and/or access by one or more of the respective processor(s) 504 of server computer 104 via cache 514. In this embodiment, persistent storage 508 includes a magnetic hard disk drive. Alternatively, or in addition to a magnetic hard disk drive, persistent storage 508 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 508 may also be removable. For example, a removable hard drive may be used for persistent storage 508. Other examples include optical and magnetic disks, thumb drives, and smart cards that are inserted into a drive for transfer onto another computer readable storage medium that is also part of persistent storage 508.

Communications unit 510, in these examples, provides for communications with other data processing systems or devices, including resources of climate database 112, demographics database 114, and postal code database 116. In these examples, communications unit 510 includes one or more network interface cards. Communications unit 510 may provide communications through the use of either or both physical and wireless communications links. Trigger mapping engine 106, trigger database 110, and other programs and data used for implementation of the present invention, may be downloaded to persistent storage 508 of server computer 104 through communications unit 510.

I/O interface(s) 512 allows for input and output of data with other devices that may be connected to server computer 104. For example, I/O interface(s) 512 may provide a connection to external device(s) 516 such as a keyboard, a keypad, a touch screen, a microphone, a digital camera, and/or some other suitable input device. External device(s) 516 can also include portable computer readable storage media such as, for example, thumb drives, portable optical or magnetic disks, and memory cards. Software and data used to practice embodiments of the present invention, e.g., trigger mapping engine 106 and trigger database 110 on server computer 104, can be stored on such portable computer readable storage media and can be loaded onto persistent storage 508 via I/O interface(s) 512. I/O interface(s) 512 also connect to a display 518.

Display 518 provides a mechanism to display data to a user and may be, for example, a computer monitor. Display 518 can also function as a touch screen, such as a display of a tablet computer.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method comprising:
receiving, by one or more computer processors, one or more variables associated with one or more rulesets;
retrieving, by one or more computer processors, data corresponding to the one or more variables, wherein the retrieved data is organized by a plurality of postal codes associated with the retrieved data, and wherein at least one of the plurality of postal codes belongs to a source geography and at least one of the plurality of postal codes belongs to a target geography;
sorting, by one or more computer processors, the retrieved data by season;
computing, by one or more computer processors, a seasonal average for each variable by associated postal code;
training, by one or more computer processors, a self-organizing map to arrange the retrieved data and the computed data associated with the source geography postal codes into one or more source clusters;
mapping, by one or more computer processors, the retrieved data and the computed data associated with the target geography to the one or more source clusters, thereby creating one or more target counterpart clusters that correspond with at least one of the one or more source clusters;
applying, by one or more computer processors, one or more cluster rulesets associated with the one or more source clusters to the corresponding one or more target counterpart clusters; and
outputting, by one or more computer processors, one or more bucket sheets, wherein each of the one or more bucket sheets is a master list of each bucket which contains the one or more cluster rulesets by postal code and by season for each bucket, and wherein each of the one or more bucket sheets corresponds to one of the one or more target counterpart clusters.

2. The method of claim 1, further comprising, generating, by one or more computer processors, one or more trigger sheets, wherein each of the one or more trigger sheets is a master table that maps marketing triggers previously defined for the source geography to one or more corresponding buckets defined for the target geography, and wherein a trigger corresponds to one or more buckets.

3. The method of claim 1, further comprising, eliminating, by one or more computer processors, one or more source clusters that do not correspond to a location in the target geography.

4. The method of claim 1, further comprising:
selecting, by one or more computer processors, one or more source postal codes that represent a centroid of each of the one or more source clusters;
determining, by one or more computer processors, the one or more cluster rulesets that apply to the centroid of each of the one or more source clusters; and
designating, by one or more computer processors, the one or more cluster rulesets that apply to the centroid of each of the one or more source clusters as rulesets corresponding to the one or more source clusters associated with the centroid.

5. The method of claim 4, wherein selecting one or more source postal codes that represent the centroid of each of the one or more source clusters further comprises determining, by one or more computer processors, the one or more postal codes with a shortest distance from all other postal codes in each of the one or more source clusters.

6. The method of claim 1, wherein mapping retrieved data associated with the target geography to the one or more source clusters thereby creating one or more target counterpart clusters further comprises measuring, by one or more computer processors, similarity between the one or more source clusters and one or more target data vectors, wherein similarity is determined utilizing a threshold Euclidian distance to a center of the one or more source clusters.

7. The method of claim 1, wherein the one or more variables associated with the one or more rulesets are selected from the group consisting of: a climatological variable, a demographic variable, and a socioeconomic variable.

8. The method of claim 7, wherein the climatological variable is selected from the group consisting of: an average temperature, an average relative humidity, an average precipitation, and an average wind speed.

9. The method of claim 7, wherein the demographic variable is selected from the group consisting of: a population density and an income per capita.

10. A computer program product comprising:
one or more computer readable storage devices and program instructions stored on the one or more computer readable storage devices, the stored program instructions comprising:
program instructions to receive one or more variables associated with one or more rulesets;
program instructions to retrieve data corresponding to the one or more variables, wherein the retrieved data is organized by a plurality of postal codes associated with the retrieved data, and wherein at least one of the plurality of postal codes belongs to a source geography and at least one of the plurality of postal codes belongs to a target geography;
program instructions to sort the retrieved data by season;
program instructions to compute a seasonal average for each variable by associated postal code;
program instructions to train a self-organizing map to arrange the retrieved data and the computed data associated with the source geography postal codes into one or more source clusters;
program instructions to map the retrieved data and the computed data associated with the target geography to the one or more source clusters, thereby creating one or more target counterpart clusters that correspond with at least one of the one or more source clusters;
program instructions to apply one or more cluster rulesets associated with the one or more source clusters to the corresponding one or more target counterpart clusters; and
program instructions to output one or more bucket sheets, wherein each of the one or more bucket sheets is a master list of each bucket which contains the one or more cluster rulesets by postal code and by season for each bucket, and wherein each of the one or more bucket sheets corresponds to one of the one or more target counterpart clusters.

11. The computer program product of claim 10, the stored program instructions further comprising, program instructions to generate one or more trigger sheets, wherein each of the one or more trigger sheets is a master table that maps marketing triggers previously defined for the source geography to one or more corresponding buckets defined for the target geography, and wherein a trigger corresponds to one or more buckets.

12. The computer program product of claim 10, the stored program instructions further comprising, program instructions to eliminate one or more source clusters that do not correspond to a location in the target geography.

13. The computer program product of claim 10, the stored program instructions further comprising:
program instructions to select one or more source postal codes that represent a centroid of each of the one or more source clusters;
program instructions to determine the one or more cluster rulesets that apply to the centroid of each of the one or more source clusters; and
program instructions to designate the one or more cluster rulesets that apply to the centroid of each of the one or more source clusters as rulesets corresponding to the one or more source clusters associated with the centroid.

14. The computer program product of claim 13, wherein the program instructions to select one or more source postal codes that represent the centroid of each of the one or more source clusters comprise program instructions to determine the one or more postal codes with a shortest distance from all other postal codes in each of the one or more source clusters.

15. The computer program product of claim 10, wherein the program instructions to map retrieved data associated with the target geography to the one or more source clusters thereby creating one or more target counterpart clusters comprise program instructions to measure similarity between the one or more source clusters and one or more target data vectors, wherein similarity is determined utilizing a threshold Euclidian distance to a center of the one or more source clusters.

16. A computer system comprising:
one or more computer processors;
one or more computer readable storage devices;
program instructions stored on the one or more computer readable storage devices for execution by at least one of the one or more computer processors, the stored program instructions comprising:
program instructions to receive one or more variables associated with one or more rulesets;
program instructions to retrieve data corresponding to the one or more variables, wherein the retrieved data is organized by a plurality of postal codes associated with the retrieved data, and wherein at least one of the plurality of postal codes belongs to a source geography and at least one of the plurality of postal codes belongs to a target geography;
program instructions to sort the retrieved data by season;
program instructions to compute a seasonal average for each variable by associated postal code;
program instructions to train a self-organizing map to arrange the retrieved data and the computed data associated with the source geography postal codes into one or more source clusters;
program instructions to map the retrieved data and the computed data associated with the target geography to the one or more source clusters, thereby creating one or more target counterpart clusters that correspond with at least one of the one or more source clusters;
program instructions to apply one or more cluster rulesets associated with the one or more source clusters to the corresponding one or more target counterpart clusters; and
program instructions to output one or more bucket sheets, wherein each of the one or more bucket sheets is a master list of each bucket which contains the one or more cluster rulesets by postal code and by season for each bucket, and wherein each of the one or more bucket sheets corresponds to one of the one or more target counterpart clusters.

17. The computer system of claim 16, the stored program instructions further comprising, program instructions to generate one or more trigger sheets, wherein each of the one or more trigger sheets is a master table that maps marketing triggers previously defined for the source geography to one or more corresponding buckets defined for the target geography, and wherein a trigger corresponds to one or more buckets.

18. The computer system of claim 16, the stored program instructions further comprising, program instructions to eliminate one or more source clusters that do not correspond to a location in the target geography.

19. The computer system of claim 16, the stored program instructions further comprising:
program instructions to select one or more source postal codes that represent a centroid of each of the one or more source clusters;
program instructions to determine the one or more cluster rulesets that apply to the centroid of each of the one or more source clusters; and
program instructions to designate the one or more cluster rulesets that apply to the centroid of each of the one or more source clusters as rulesets corresponding to the one or more source clusters associated with the centroid.

20. The computer system of claim 16, wherein the program instructions to map retrieved data associated with the target geography to the one or more source clusters thereby creating one or more target counterpart clusters comprise program instructions to measure similarity between the one or more source clusters and one or more target data vectors, wherein similarity is determined utilizing a threshold Euclidian distance to a center of the one or more source clusters.
